(19) United States
(12) Patent Application Publication
(10) Pub. No.: US 2002/0064415 A1
(43) Pub. Date: May 30, 2002

(54) Fastener

(75) Inventors: Holger Hein, Augsburg (DE); Wilhelm Neukam, Bobingen (DE)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(73) Assignee: Fujitsu Siemens Computers GmbH, Muenchen (DE)

(21) Appl. No.: 09/962,309

(22) Filed: Sep. 26, 2001

(30) Foreign Application Priority Data
Nov. 9, 2000 (DE) 100 55 455.5

(51) Int. Cl. F16B 1/00; F16G 11/00; F16L 35/00; B65D 59/00

(52) U.S. Cl. 403/12

(57) ABSTRACT

The invention concerns a fastener for screwless fixing of components (1) in a mounting cage (3).

Through the invention, the components (1) are fixed in the mounting cage (3) with a support (5) with projecting pins (6) which can be inserted into corresponding threaded holes (2) of the components and which are latched to the mounting cage (3) after sliding in the components (2) with attached support (5).

The invention concerns a fastener for fixing of components, such as for example driving mechanisms in a mounting cage with a support with pins arranged thereon which are arranged such that they are insertable into the threaded holes of the components.

Up until now, screwing the components into the mounting cage has been known, whereby the appropriate bore holes are present on the mounting cage in its sidewalls and the corresponding threaded holes are present in the components.

A screwless fastening is known from EP 0 763 792 A1 where the components are laid on a flat plastic element the lateral elements of which can be folded through foil hinges against the sidewalls of the components. The lateral elements are provided with lugs which engage the appropriate threaded holes of the components.

The plastic element with the components accommodated therein is pushed into the mounting cage.

This solution has the disadvantage that first, assembly is relatively expensive as each component must be driven in from the plastic element and the lugs must be pressed into the threaded holes on both sides. Moreover there arises a problem with several components arranged one over the other, since with the solution in accordance with EP 0 763 792 A1, the underside of each component is also surrounded by the plastic element, and consequently the components must necessarily be set at a distance in the thickness of the plastic element.

Underlying the invention is therefore the objective of perfecting representative fasteners such that the disadvantages mentioned above are eliminated.

This objective is accomplished in accordance with the invention in that the fastener consists only of the support, this being constructed flat and only being attachable to a sidewall of the component.

Consequently the support need only be attached to a sidewall of the component in order to immobilize this in the mounting cage. Driving in the components as with the state of the art is unnecessary.

The support is advantageously constructed with its base area smaller than the sidewalls of the components so that several components with attached supports arranged one above the other can be pushed into the mounting cage.

The support is preferably provided with a latch which interacts with the mounting cage and consequently prevents the components from being pulled out of the mounting cage again.

The latch is not, however, absolutely necessary. Thus, it is also, for example, possible to provide a latch on the mounting cage which from behind grasps an edge of the support after insertion.

In order to guarantee a good fixation of the supports in the threaded holes of the components, each pin is constructed with an annular bulge in a preferred development. This annular bulge brings about a clawing into the threaded holes through which the support is relatively well fixed on the sidewall of the components after attachment.

The latch is preferably constructed as a locking hook which stands on the opposite side as the pins from the support.

The support is preferably made of plastic and is consequently also very economical in its manufacture.

Attachment can be made on both sides of the components and this also permits an assembly without removing the front panel of the components.

Likewise, the support can be inserted as spacing unit into the mounting cage from inside in the event of components with abnormal threaded holes, whereby in this case, the fixation of the components takes place after pushing in using screws which are inserted through appropriate bore holes in the mounting cage for abnormal components and screwed into the components through the plastic support.

Further advantageous embodiments of the invention are disclosed in the dependent claims as well as in the subsequent description.

The invention will be explained in greater detail on the basis of an embodiment represented in the drawings, wherein:

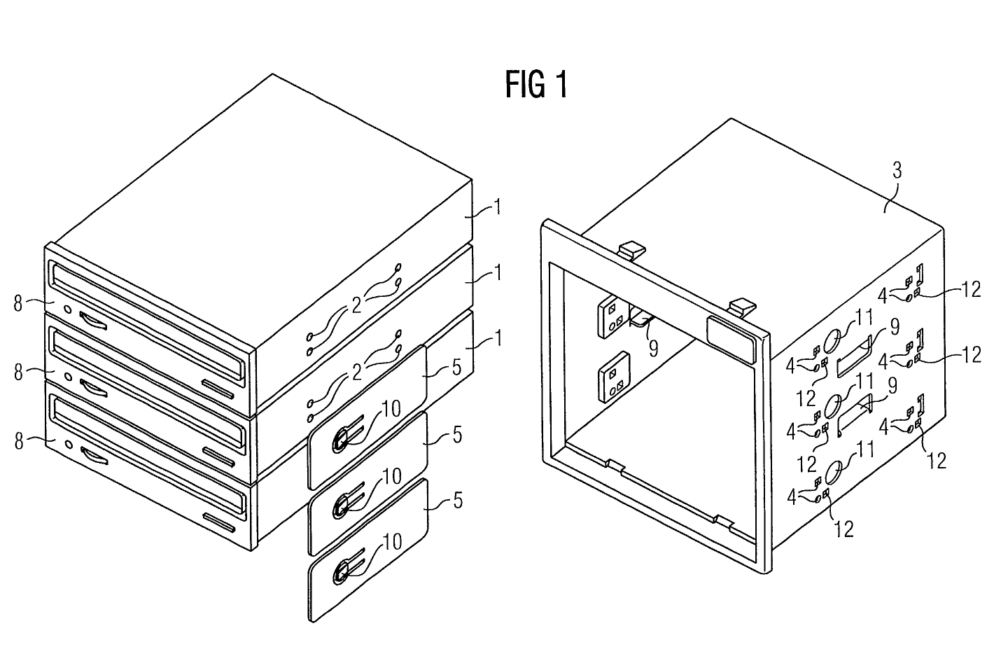

FIG. 1 Shows an exploded representation of tree components, three supports and a mounting cage,

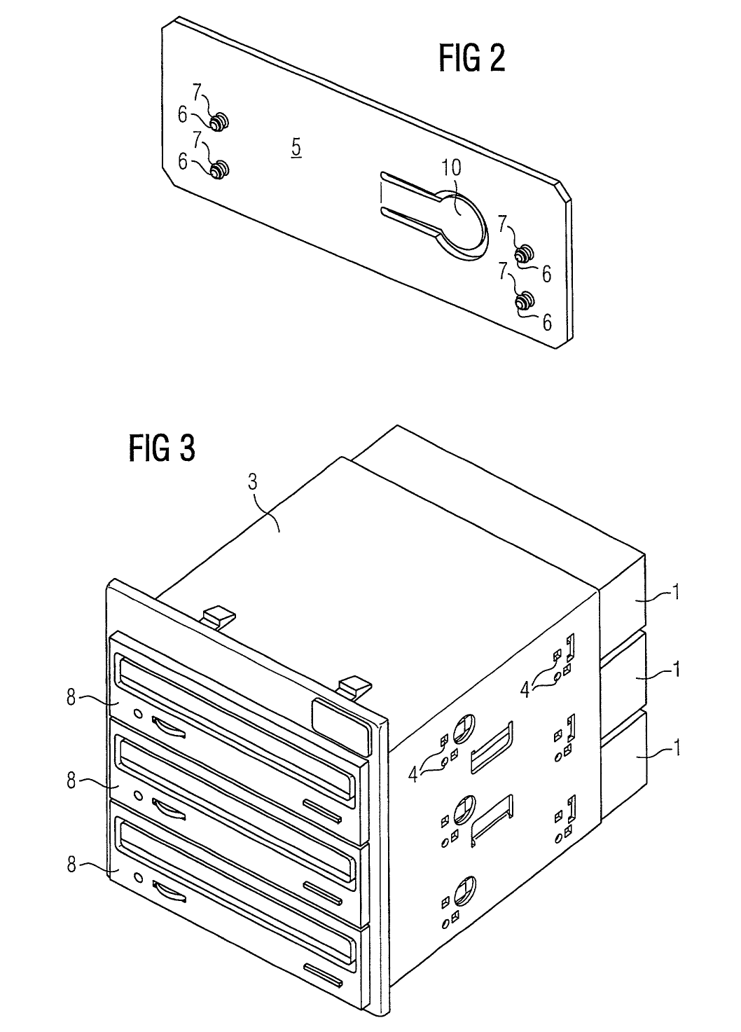

FIG. 2 Reveals a support in oblique view and

FIG. 3 Depicts the parts represented in FIG. 1 in the assembled state.

FIG. 1 shows three components 1 as they are used with computers. These components can, for example, be hard disk drives (HD's), CD ROM drives, zip drives or the like.

The components 1 are as a rule standardized in their size and have threaded holes 2 on the side through which the components 1 are fixed through screws in the computer directly or through a mounting cage 3 as represented in FIG. 1 right. For immobilization in the mounting cage 3, bore holes 4 are provided in its sidewalls which are arranged in the same pattern as the threaded holes 2 on the sidewalls of the components.

As already mentioned in the introduction to the description, installing the components and screwing them in is manual labor and demands relatively much processing time. For this reason, one has switched in the meantime to inventing screwless fastening methods.

In accordance with the present invention, only one support 5 is used for this, as it is also represented in oblique view in FIG. 2. The support 5 is constructed flat and has pins 6 projecting out of the surface on the one side exactly in contact spacing to the threaded holes 2 on the components. Each pin is provided with an annular bulge 7 which contributes to the pins being better fixed in the threaded holes 2 when they are pressed into threaded holes 2. The annular bulge 7 here hooks in the threaded passages.

The support 5 is a plastic element and thus very easy to manufacture and also very easy to install since it only needs to be pressed into the threaded holes 2 with the pins 6.

If the support 5 is attached to the component 1, the latter is simply pushed into the mounting 3.

The support 5 has the great advantage that the front panel of the component 1 does not also need to be removed.

Moreover, the support 5 has a surface which is smaller than the sidewall of a component 1 so that, as represented in FIGS. 1 and 3, several components can be pushed into the mounting cage 3 one over the other without further ado.

For adjusting the height, straps 9 are separated out and bent 90° inward. The underside of a component 1 sits on these straps 9 in any given case.

To fix the components against being pulled out, a latch is provided between the support 5 and the sidewall of the mounting cage 3. In the embodiment represented, the latch 10 is constructed as a locking hook in the support 5 and the matching latch as a recess 11 at all times on the corresponding spot in the mounting cage 3.

Likewise it is also nonetheless possible to provide locking hooks on the sidewall of the mounting cage 3 which grasps behind the front edge of support 5 in the inserted state.

Consequently, a fastener for fixing components in a mounting cage is consequently created through the support 5 which is extremely economical to manufacture and which can also be easily installed.

In those cases in which the components I have no standardized threaded holes, it is possible to insert the support 5 with its pins 6 from the inside through the bore holes 4 and to push the components in afterward. The mounting cage 3 is as a rule also provided with bore holes 12 for non-standard drives, that is, drives where the threaded holes 2 are not arranged in contact spacing, through which then the non-standard components or drives can be immobilized with screws through the plastic support 5.

The support 5 has the advantage in comparison to the screwless fastening methods known from the state of the art that it is only inserted into the component on one side, convenient to manufacture, easy in installation as well as more economical in the use of structural space.

1. Fastener for fixing components (1), for example such as drives in a mounting cage (3), with a support (5) and pins (6) arranged thereupon which are arranged such that they are insertable into the threaded holes (2) of the components, characterized in that the fastener consists only of a support (5), this is constructed flat and is attachable only to a sidewall of the component.

2. Fastener according to claim 1, characterized in that the support (5) is constructed smaller in its base area than the lateral wall of a component (1).

3. Fastener according to one of claims 1 or 2, characterized in that it is provided with a latch.

4. Fastener according to claim 3, characterized in that the latch is constructed as a locking hook (10) on the support it protrudes on the opposite side of the pins (6) of the support.

5. Fastener according to one of claims 1 to 4, characterized in that an annular bulge (7) is constructed on the pins (6).

6. Fastener according to one of claims 1 to 5, characterized in that the support is made of plastic.

7. Fastener according to one of claims 1 to 6, characterized in that the support (5) can be installed without removing the front panel of the components (1).

8. Mounting cage (3) for receiving components (1) such as drives with inwardly projecting straps (9) for fixing the height of the components (1) and recesses (11) in the sidewalls which cooperate with latches of a fastener according to one of claims 1 to 7 for fixing the components (1) against being pulled out.

9. Mounting cage (3) with inserted components (10 which can be fixed vertically through straps (9) bent inwardly from the sidewalls and horizontally by means of a fastener according to one of claims 1 to 7.
